(19) United States
(12) Patent Application Publication
(10) Pub. No.: US 2007/0178027 A1
(43) Pub. Date: Aug. 2, 2007

(54) Organic material decomposition and treatment apparatus using magnetic wave

(76) Inventor: Young Ho Park, Park Ridge, NJ (US)

Correspondence Address: LADAS & PARRY, 26 WEST 61ST STREET, NEW YORK, NY, 10023, US

(21) Appl. No.: 11/369,029

(22) Filed: Mar. 6, 2006

(30) Foreign Application Priority Data
Jan. 31, 2006 (KR) 10-2006-0009381

(51) Int. Cl. B09B 3/00

(52) U.S. Cl. 422/184.1

(57) ABSTRACT

An organic material decomposition and treatment apparatus using a magnetic wave is provided, in which organic materials can be well decomposed without creating or producing harmful materials. The apparatus comprises a body; a first input port which is provided at an upper side of the body at a certain inclination angle and is opened and closed, with a lid being installed at the first input port; a discharge port which is provided at a front side of the body and is opened and closed, with a lid being installed at the discharge port; an exhaust tube which is installed at a back side of the body; and a magnetic wave generator which is installed at both sides of the body, wherein the organic material is decomposed and treated by the magnetic waves induced from the magnetic wave generator into the interior of the body.

### BACKGROUND OF THE INVENTION

1. Field of the Invention

The present invention relates to an organic material decomposition and treatment apparatus, and in particular to an organic material decomposition and treatment apparatus using a magnetic wave in which it is possible to achieve a non-pollution decomposition without any harmful material creation and discharge when a waste material of a petrochemical industry organic material and an organic substance is decomposed and treated.

2. Description of the Background Art

In modern society, the use of a disposable type item or a packing material increases, so that an organic material increases and pollutes environments. As a life standard is enhanced, and industrialization is accelerated, the use of organic materials keeps increasing. The kinds of organic materials are being diversified. The use of organic materials does not decrease despite of the efforts by government such as waste measured rate system, waste separation and disposal system.

Generally, the organic materials have been treated by a burying method, an incineration method or a recycling method. In Korea, the burying method has been adapted, which method has been widely used in the USA. However, in the burying method, it is impossible to recycle the organic materials. In Korea with small area, the burying method cannot be adapted for long time period.

So as to overcome the above problems, the Korean government stopped burying food wastes on January 2005. Namely, according to the regulations, only residuals produced after incineration, compost treatment or extermination could be buried, so that the organic materials can be treated based on incineration and recycling methods.

However, the recycling method may not be economical and may produce secondary pollutants during the treatment.

In the case of the incineration method, various harmful materials such as dioxin, hydrogen chloride, chlorine, hydrogen fluorine, heavy metals, carbon monoxide, nitric compounds, sulfate compounds, etc. are produced a lot for thereby destroying environments and speeding up earth warming phenomenon. So as to comply with the pollutant discharge regulations, an expensive dust collection facility or an expensive high temperature combustion system should be installed. Therefore, the incineration method cannot be practically adapted to the industry.

### SUMMARY OF THE INVENTION

Accordingly, it is an object of the present invention to provide an organic material decomposition and treatment apparatus using a magnetic wave in which organic materials can be well decomposed without creating or producing harmful materials.

To achieve the above object, there is provided an organic material decomposition and treatment apparatus which comprises a body; a first input port which is provided at an upper side of the body at a certain inclination angle and is opened and closed, with a lid being installed at the first input port; a discharge port which is provided at a front side of the body and is opened and closed, with a lid being installed at the discharge port; an exhaust tube which is installed at a back side of the body; and a magnetic wave generator which is installed at both sides of the body, wherein the organic material is decomposed and treated by the magnetic waves induced from the magnetic wave generator into the interior of the body.

There is further provided a second input port which is protruded from an opening formed at a center of the lid of the first input port, with the opening being provided with a certain area, and is opened and closed, with a lid being installed at the second input port, wherein a container having a circular cross section is installed in the interior of the second input port for receiving organic materials therein, and said container is rotatable by a rotation lever installed at an outer side of the second input port.

A filter is installed at an outer side of the exhaust tube.

There is further provided a protection cover installed at both sides of the body so that an external discharge of the magnetic wave is prevented.

The magnetic wave generators are installed opposite to each other.

There is further provided a magnetic wave tube installed between the body and the magnetic wave generator, so that the magnetic waves are induced from the magnetic wave generator into the interior of the body through the magnetic wave tube, and an adjusting valve is installed at the magnetic wave tube.

The magnetic wave generator includes an upper casing and a lower casing, which are engaged with each other based on a protrusion-engagement method, and a magnet receiving port is formed at a center of each of the upper and lower casings, respectively, and a semicircular opening is formed at one side of each of the same, respectively, with a thread groove being formed at the opening, so that the magnetic wave tube is thread-engaged at the opening.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating an organic material decomposition and treatment apparatus according to an embodiment of the present invention;

FIGS. 2 and 3 are perspective views illustrating an organic material decomposition and treatment apparatus according to another embodiment of the present invention;

FIG. 4 is a perspective view illustrating a magnetic wave generator according to the present invention;

FIG. 5 is a disassembled view illustrating a magnetic wave generator of FIG. 4;

FIG. 6 is a cross sectional view taken along line A-A′ of FIG. 4; and

FIGS. 7A through 7C are schematic views illustrating a use state of an organic material decomposition and treatment apparatus of FIG. 2.

### DETAILED DESCRIPTION OF THE PREFERRED EMBODIMENTS

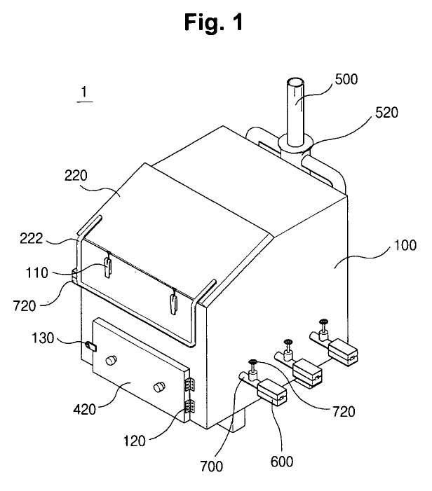

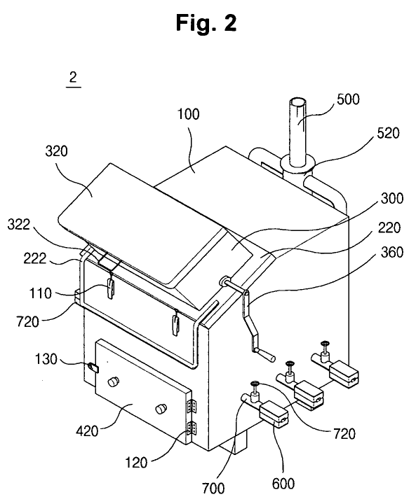

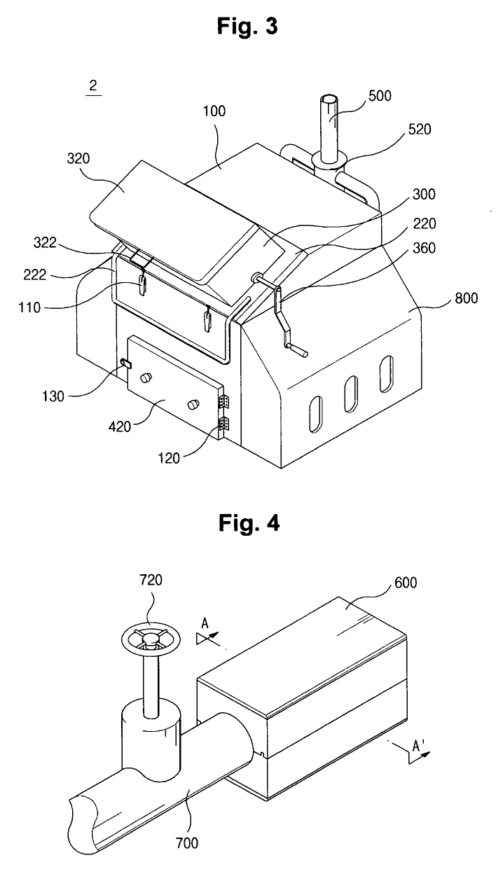

FIG. 1 is a perspective view illustrating an organic material decomposition and treatment apparatus according to an embodiment of the present invention, and FIGS. 2 and 3 are perspective views illustrating an organic material decomposition and treatment apparatus according to another embodiment of the present invention.

As shown in FIG. 1, an organic material decomposition and treatment apparatus 1 according to the present invention comprises a body 100, a first input port 200, a discharge port 400, an exhaust tube 500, and a magnetic wave generator 600.

Here, the body 100 may be formed in a rectangular shape or a cubic shape and may be provided with a certain inner space in which an organic material is inputted and decomposed. The body 100 is preferably made of a steel plate, so that heat generated ruing a decomposition of organic materials is not transferred to the outside for thereby enhancing a heat keeping performance. It is possible to prevent the input of external air in maximum. As shown in FIG. 3, a protection cover 800 is preferably installed at both sides of the body 100, so that a magnetic wave is not transferred to the outside, and the user of the apparatus can be protected.

As shown in FIG. 1, the first input port 200 is provided at an upper side of the body 100 at a certain inclination for thereby easily inputting organic materials. A lid 220 is installed so as to open and close the first input port 200 so that the body 100 is substantially sealed. One side of the lid 220 is rotatably hinged at an upper side of the body 100, and the other side of the same is engaged at the front side of the body 100 by a locking device 110. Here, the lid 220 has a certain size larger than the first input port 200 so that the body 100 is substantially sealed. A grip 222 is preferably installed at an outer side of the lid 220 so that the lid 220 can be easily opened and closed.

As shown in FIGS. 2 and 3, the organic material decomposition and treatment apparatus 2 according to the present invention further includes a second input port 300 protruded from the first input port 200. A certain opening is formed at the center of the lid 220 of the first input port 200. The second input port 300 is protruded from the opening. A lid 320 is installed at the second input port 300 so as to open and close the same like in the first input port 200. One side of the lid 320 is rotatably hinged at the back side of the second input port 300, and the other side of the same is engaged at the front side of the second input port 300 by a locking device (not shown). The size of the lid 320 is larger than the second input port 300 for a better sealing. A grip 322 is preferably installed at an outer side of the lid 320 for easily opening and closing the lid 320.

A container 340 is provided in the interior of the second input port 300 for receiving organic materials therein. Here, the container 340 has a circular cross section and is closely contacted with the inner surface of the second input port 300. The container 340 is rotatable so that the organic material is inputted into the interior of the body 100. A rotation lever 360 is provided so as to allow the container 340 to rotate. The rotation lever 360 passes through the second input port 300, and the container 340 is engaged with the rotation lever 360 in the interior of the second input port 300. When the rotation lever 360 is rotated, the container 340 rotates.

The second input port 300 is installed at the first input port 200, and the rotatable container 340 is installed in the interior of the second input port 300, so that the input of the external air into the body 100 is minimized when the organic material is inputted. In a state that the first input port 200 is closed, when the second input port 300 is opened, since the container 340 in the interior of the second input port 300 is closely contacted with the inner surface of the second input port 300, the input of the external air into the body 100 is blocked. Here, the organic material is inputted into the container 340, and the second input port 300 is closed, and then the container 340 is rotated for thereby inputting the organic material into the body 100. In a state that the input of the external air is minimized, the organic material is inputted into the interior of the body 100. The more detailed descriptions will be provided later.

The discharge port 400 is provided at the front side of the body 100, preferably, is provided at a front lower side of the body 100. A lid 420 is installed at the discharge port 400 for opening and closing the same like in the first input port 200 and the second input port 300. One side of the lid 420 is rotatably hinged at the front side of the body, and the other side of the same is engaged by a locking device 130. The size of the lid 420 is larger than the discharge port 400 for a better sealing.

The exhaust tube 500 is installed at a back side of the body 100, so that gas generated during the decomposition of the organic material is discharged to the outside. In addition, a filter 520 is installed at an outer side of the exhaust tube 500, so that gas generated during the decomposition of the organic material becomes harmless, and bad smell is removed.

The magnetic wave generator 600 is preferably installed at both sides of the body 100, more preferably, is installed at both lower sides of the body 100 in an opposite structure. The magnetic wave generator 600 is installed ay both sides of the body, respectively, in such a manner that the magnetic wave generators 600 are opposite from the pole N to the pole S. A magnetic field is generated in the interior of the body 100.

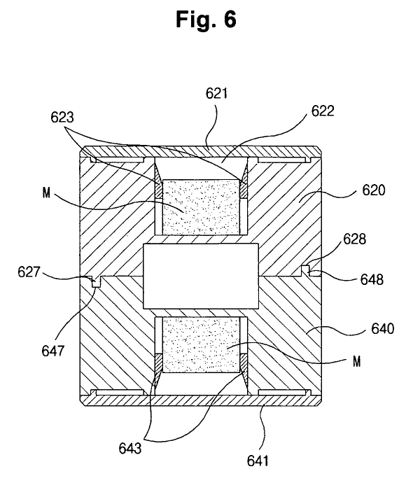

As shown in FIGS. 2 through 6, a magnetic wave tube 700 is preferably installed between the body 100 and the magnetic wave generator 600. The magnetic wave tube 700 guides the magnetic wave generated by the magnetic wave generator 600 in the direction of the body 100. The magnetic wave tube 700 engaged at one side of the magnetic wave generator 600 passes through the both lower sides of the body 100, so that the magnetic waves generated by the magnetic wave generator 600 is guided into the interior of the body 100 through the magnetic wave tube 700. An adjusting valve 720 is preferably installed at the magnetic wave tube 700, so that the intensity of the magnetic wave guided into the interior of the body 100 can be adjusted.

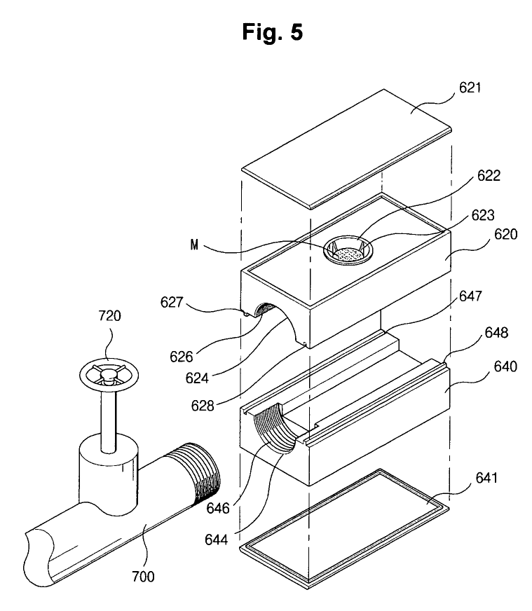

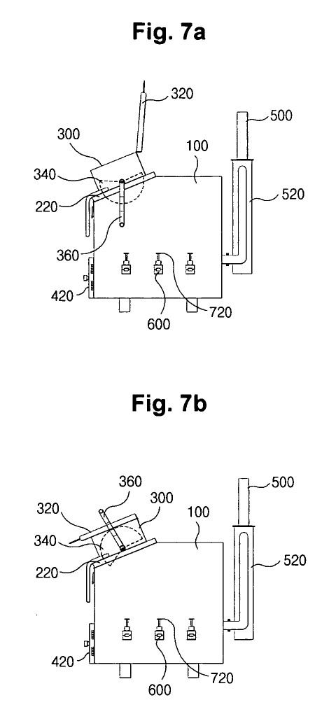

As shown in FIGS. 4 through 6, the magnetic wave generator 600 is formed of an upper casing 620 and a lower casing 640. The upper casing 620 and the lower casing 640 are made of a plastic material or a rubber material. Semi-circular openings 624 and 644 having screw grooves 626 and 646 are formed at each side of the same, respectively, and magnet receiving portions 622 and 642 are formed at the center of the same, respectively, for thereby receiving the magnets 623 and 643 therein. A plurality of fixing members 623 and 643 are installed at the inner sides of the magnetic receiving portions 622 and 642 of the upper casing 620 and the lower casing 640. The magnets M are fixed by the fixing members 623 and 643. Here, the magnets M according to the present invention are neodymium permanent magnets, and the magnetic receiving portions 622 and 642 are formed in circular forms so as to fix the magnets M. The magnet receiving portions 622 and 642 may not be limited to the disclosed circular shapes, namely, may be formed in various shapes including a rectangular shape. One magnet M may be received into each magnet receiving port 622, 642 of the upper casing 620 and the lower casing 640, respectively. Therefore, as shown in FIG. 6, two magnets M are received at one magnetic wave generator 600. The upper casing 620 and the lower casing 640 are opened and closed by the lids 621 and 641 each having a protrusion. The upper casing 620 and the lower casing 640 have rectangular protrusions 627 and 647 and concave grooves 628 and 648. A circular opening having a screw groove is formed at one side of the magnetic wave generator 600, and the magnetic wave tube 600 is thread-engaged at the opening.

Here, the magnetic wave generator 600 may be provided in multiple numbers. Preferably, two through ten magnetic wave generators may be provided. The magnets M are formed of neodymium permanent magnets each having an intensity of 5000 to 7000 Gauss. However, the above construction is not limited. The number of the magnetic wave generators 600 is determined based on the kinds of organic material to be processed or the size (volume) of the body 100. For example, in the case that the volume is 0.5 m³, two magnetic wave generators (totally four generators, and eight magnets) are installed at both side of the container body, respectively. In the case that the volume is 1.0 m³, three magnetic wave generators (totally six generators, and twelve magnets) are installed at both sides of the container body, respectively. In the case that the volume is 1.5 m³, five magnetic wave generators (totally ten generators, and twenty magnets) are installed at both sides of the container body, respectively. As the volume increases, the number of the magnetic wave generator increases. Here, the organic material decomposition apparatus is preferably installed in the direction of the south for thereby more efficiently generating magnetic waves.

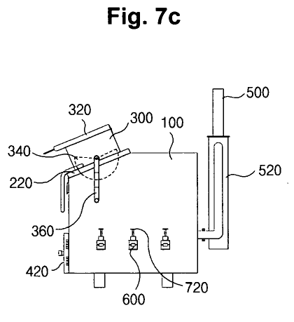

FIGS. 7A through 7C are schematic views illustrating a use state of an organic material decomposition and treatment apparatus of FIG. 2.

The use state of the organic decomposition and treatment apparatus 2 according to the present invention will be described with reference to FIGS. 7A through 7C.

In the case that the organic material decomposition and treatment apparatus 2 is used, the lid 220 of the first input port 200 is opened, and the organic material is directly inputted into the interior of the body 100, and then the lid 220 of the first input port 200 is closed, so that the organic material is decomposed. Since the method of opening the second input port 300 is more effective so as to prevent the input of external air, only the method of inputting organic materials through the second input port 300 will be described. As the organic materials which will be decomposed based on the organic material decomposition and treatment apparatus according to the present invention, there are nylon, plastic, vinyl chloride, resin, urethane material, petrochemical products, paper, wood, rubber, etc.

As shown in FIGS. 7A through 7C, the lid 320 of the second input port 300 is opened, and then the organic material is inputted into the container 340 installed in the interior of the second input port 300. Here, since the container 340 is closely contacted with the inner surface of the second input port 300, the input of the external air into the body 100 is blocked. When the lid 320 of the second input port 300 is closed, the body 100 is sealed. When the rotation lever 360 provided at the outer side of the second input port 300 is rotated, the container 340 in the interior of the second input port 300 also rotates. The organic material received in the container 340 is inputted into the interior of the body 100. At this time, when the rotation lever 360 is rotated 180°, all of the organic material received in the container can be inputted into the interior of the body 100. The container 340 in the interior of the second input port 300 returns to its original position by rotating the rotation lever 360.

In the above state, when the adjusting valve 720 of the magnetic wave tube 700 installed at both sides of the body 100 is opened, the magnetic waves generated by the magnetic wave generator 600 are induced into the interior of the body 100 through the magnetic wave tube 700. The organic material is reacted with the magnetic waves and is decomposed, and at the same time decomposition heat is generated. In other words, the organic material is slowly decomposed based on the vibration of the magnetic wave induced into the interior of the body 100, and at the same time, heat energy is discharged. Therefore, the decomposition of the organic material is accelerated, and carbonization is continuously performed. A dried gas is generated based on the decomposition heat generated during the decomposition of the organic materials, and all of the organic materials are decomposed based on a convection operation. Since the organic material is decomposed not by the combustion method, harmful gases are not generated.

When the decomposition of all of the organic material is finished, the residuals are removed by opening the discharge port 400 provided at the lower side of the body 100. Since the volume of the residuals produced after the decomposition of the organic material decreases a few hundreds times as compared to the original volume at the time when the organic materials are inputted, the treatment work can be easily performed.

As described above, the organic material decomposition and treatment apparatus a magnetic wave according to the present invention has the following effect.

First, organic materials are decomposed by magnetic waves, not by a combustion method, in a state that the organic materials are sealed without air. Since a harmful gas such as dioxin or CO₂ does not occur, the organic materials can be treated without producing pollutants.

Second, the organic materials can be continuously decomposed and treated by decomposition heat generated during the decomposition of organic materials, so that a motor or a burner is not additionally needed for thereby decreasing the cost.

Third, since the input ports are provided in multiple numbers, it is possible to continuously input the organic material based on the fixed amount in a state that the input of external air is substantially blocked.

Fourth, after the organic materials are decomposed, since the volume of the residuals decreases to 1/200 to 1/300 as compared to the original volume, the treatment work is easy. The residuals may be used as good quality fertilizer or soil improving agents.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An organic material decomposition and treatment apparatus, comprising:
a body;
a first input port which is provided at an upper side of the body at a certain inclination angle and is opened and closed, with a lid being installed at the first input port;
a discharge port which is provided at a front side of the body and is opened and closed, with a lid being installed at the discharge port;
an exhaust tube which is installed at a back side of the body; and
a magnetic wave generator which is installed at both sides of the body, wherein the organic material is decomposed and treated by the magnetic waves induced from the magnetic wave generator into the interior of the body.

2. The apparatus of claim 1, further comprising a second input port which is protruded from an opening formed at a center of the lid of the first input port, with the opening being provided with a certain area, and is opened and closed, with a lid being installed at the second input port, wherein a container having a circular cross section is installed in the interior of the second input port for receiving organic materials therein, and said container is rotatable by a rotation lever installed at an outer side of the second input port.

3. The apparatus of claim 1, wherein a filter is installed at an outer side of the exhaust tube.

4. The apparatus of claim 1, further comprising a protection cover installed at both sides of the body so that an external discharge of the magnetic wave is prevented.

5. The apparatus of claim 1, wherein said magnetic wave generators are installed opposite to each other.

6. The apparatus of claim 5, further comprising a magnetic wave tube installed between the body and the magnetic wave generator, so that the magnetic waves are induced from the magnetic wave generator into the interior of the body through the magnetic wave tube, and an adjusting valve is installed at the magnetic wave tube.

7. The apparatus of claim 6, wherein said magnetic wave generator includes an upper casing and a lower casing, which are engaged with each other based on a protrusion-engagement method, and a magnet receiving port is formed at a center of each of the upper and lower casings, respectively, and a semicircular opening is formed at one side of each of the same, respectively, with a thread groove being formed at the opening, so that the magnetic wave tube is thread-engaged at the opening.

8. The apparatus of claim 2, wherein a filter is installed at an outer side of the exhaust tube.

9. The apparatus of claim 2, further comprising a protection cover installed at both sides of the body so that an external discharge of the magnetic wave is prevented.

10. The apparatus of claim 2, wherein said magnetic wave generators are installed opposite to each other.

11. The apparatus of claim 10, further comprising a magnetic wave tube installed between the body and the magnetic wave generator, so that the magnetic waves are induced from the magnetic wave generator into the interior of the body through the magnetic wave tube, and an adjusting valve is installed at the magnetic wave tube.

12. The apparatus of claim 11, wherein said magnetic wave generator includes an upper casing and a lower casing, which are engaged with each other based on a protrusion-engagement method, and a magnet receiving port is formed at a center of each of the upper and lower casings, respectively, and a semicircular opening is formed at one side of each of the same, respectively, with a thread groove being formed at the opening, so that the magnetic wave tube is thread-engaged at the opening.
